(19) United States
(12) Patent Application Publication
(10) Pub. No.: US 2022/0243509 A1
(43) Pub. Date: Aug. 4, 2022

(54) HINGE AND FOLDABLE EQUIPMENT INCLUDING HINGE

(71) Applicant: SIMOTEC CO., LTD., Higashiosaka-shi, Osaka (JP)

(72) Inventors: Yoshiharu TAKAHASHI, Higashiosaka-shi, Osaka (JP); Hideo HOTOMI, Higashiosaka-shi, Osaka (JP)

(21) Appl. No.: 17/622,308

(22) PCT Filed: Aug. 28, 2020
(86) PCT No.: PCT/JP2020/032671

§ 371 Date: Dec. 23, 2021

(30) Foreign Application Priority Data
Sep. 4, 2019 (JP) 2019-161542

(51) Int. Cl. E05D 3/12; F16C 11/04

(52) U.S. Cl. CPC E05D 3/12; E05Y 2900/606; F16C 11/04

(57) ABSTRACT

This hinge 1, which is provided in a rotation part of a device that can be opened and closed, comprises: a plurality of rotation members that are arranged side by side in a direction perpendicular to a rotary shaft of the rotation part; and a connection member that connects adjacent rotation members while maintaining a state in which adjacent surfaces of the adjacent rotation members abut each other, wherein the surface of the rotation member on a side facing the adjacent rotation member comprises a fully open abutting part that abuts the adjacent rotation member in a fully opened state of the rotation part, and a closed abutting part that abuts the adjacent rotation member in a closed state of the rotation part.

### CROSS REFERENCE TO RELATED APPLICATIONS

This is the U.S. national stage of application No. PCT/JP2020/032671, filed on Aug. 28, 2020. Priority under 35 U.S.C. § 119(a) and 35 U.S.C. § 365(b) is claimed from Japanese Application No. 2019-161542, filed Sep. 4, 2019, the disclosure of which is also incorporated herein by reference.

### TECHNICAL FIELD

The present invention relates to a technology for a hinge provided in a rotation part of openable and closable equipment.

### BACKGROUND ART

In the related art, various hinges provided in rotation parts of openable and closable equipment are known.

Further, some of the hinges are provided in rotation parts of flexible displays that are foldable (see Patent Literature 1).

### CITATIONS LIST

### Patent Literature

Patent Literature 1: JP-A 2017-510065 Gazette

### SUMMARY OF INVENTION

### Technical Problems

Such a hinge, however, includes a plurality of gear members, connection brackets, and the like and thus has a relatively complicated structure for maintaining a fully opened state or closed state of the rotation part.

The present invention has been made in view of the above-described circumstances, and it is therefore an object of the present invention to provide a hinge capable of maintaining a fully opened state or closed state of a rotation part with a simple structure.

### Solutions to Problems

The problems to be solved by the present invention are as described above, and solutions to the problems will be described below.

Specifically, according to a first aspect, there is provided a hinge provided in a rotation part of openable and closable equipment, the hinge including a plurality of rotation members arranged side by side in a direction orthogonal to a rotation axis of the rotation part; and a connection member that connects the rotation members adjacent to each other while maintaining a state where adjacent surfaces of the rotation members adjacent to each other abut each other. A surface of each of the rotation members facing an adjacent rotation member includes a fully open abutting part that abuts the adjacent rotation member in a fully opened state of the rotation part and a closed abutting part that abuts the adjacent rotation member in a closed state of the rotation part.

According to a second aspect, the surface of each of the rotation members facing the adjacent rotation member is formed in a polygonal shape by the fully open abutting part and the closed abutting part when viewed along the rotation axis of the rotation part, the fully open abutting part and the closed abutting part being contiguous with each other.

According to a third aspect, the number of the rotation members is at least three.

According to a fourth aspect, each of the rotation members includes a support hole opened on a surface of the rotation member in an axial direction of the rotation axis of the rotation part, the connection member is a rod member and includes a pair of extending portions and a portion connecting the pair of extending portions, and the connection member has one of the extending portions inserted into the support hole of one of the rotation members adjacent to each other and has an other of the extending portions inserted into the support hole of the other of the rotation members adjacent to each other to connect the rotation members adjacent to each other.

According to a fifth aspect, there is provided foldable equipment including a hinge according to any one of first to fourth aspects.

### Advantageous Effects of Invention

The effects of the present invention are as follows.

Specifically, according to the present invention, it is possible to maintain the fully opened state or closed state of the rotation part with a simple structure.

### BRIEF DESCRIPTION OF DRAWINGS

FIG. 1 is a plan view of a flexible display in a fully opened state, the flexible display including hinges according to an embodiment of the present invention.

FIG. 2 is a perspective view of the hinge.

FIG. 3 is a front view of the hinge.

FIG. 4 is a plan view of the hinge.

FIG. 5 is a front view of the hinge in a closed state.

FIG. 6 is a front view of the hinge when the hinge is rotating.

FIG. 7 is a plan view of the hinge.

FIG. 8 is a perspective view of the hinge.

FIG. 9 is a front view of the hinge.

FIG. 10 is a front view of the hinge in the closed state.

FIG. 11 is a front view of the hinge in the fully opened state.

FIG. 12 is a front view of the hinge.

FIG. 13 is a plan view of the hinge.

FIG. 14 is a perspective view of the hinge.

### DESCRIPTION OF EMBODIMENT

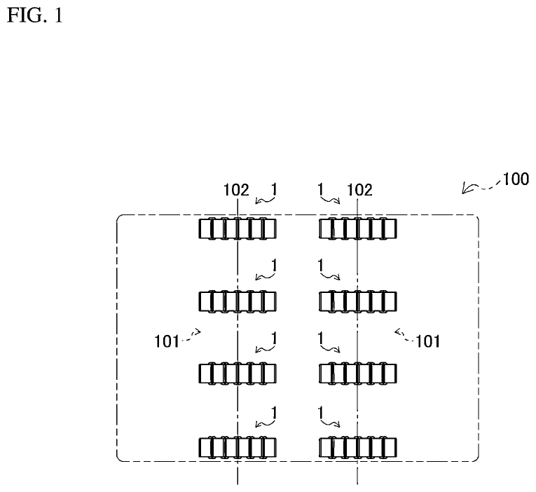

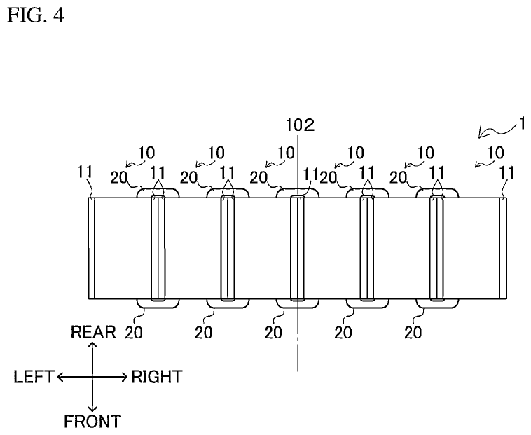

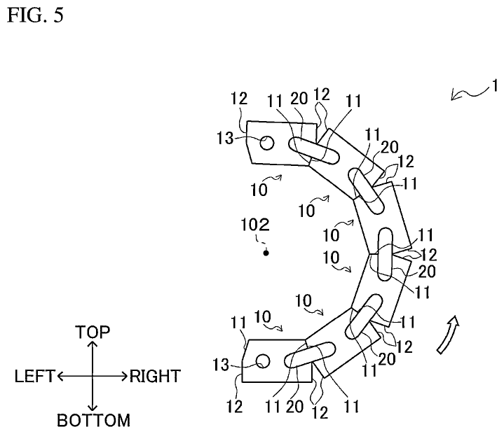

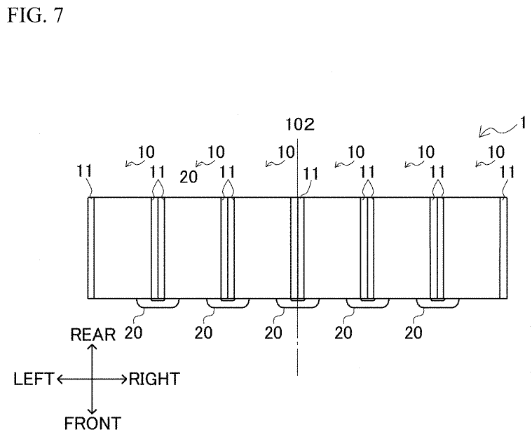

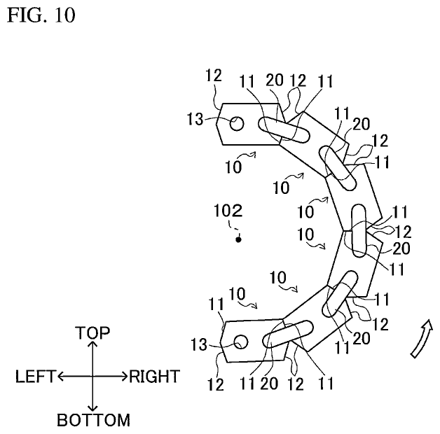

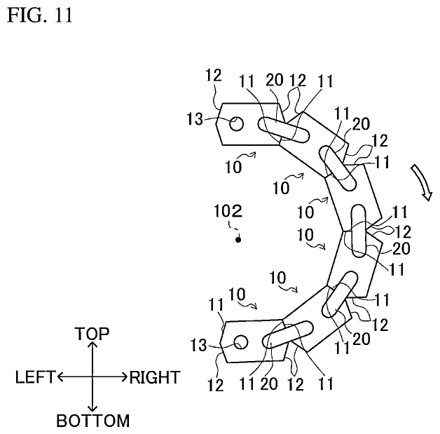

A description will be given below of a hinge 1 according to an embodiment of the present invention with reference to FIG. 1 to FIG. 14.

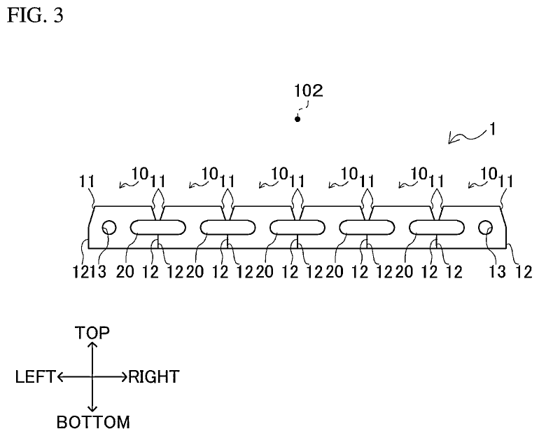

In the following description, the upper side of FIG. 3, that is, the upper side when viewed along the axial direction of a rotation axis 102 with the hinge 1 in a fully opened state (with a rotation part 101 in a fully opened state), is the upper side of the hinge 1, and the left-right direction of FIG. 3 is the left-right direction of the hinge 1, but the direction of the hinge 1 is not limited to such a direction.

The hinge 1 is provided in a rotation part of openable and closable equipment. Hereinafter, a structure where the hinge 1 is provided in the rotation part 101 of a flexible display 100 will be described, but equipment in which the hinge 1 is provided, the use of the hinge 1, and the like are not limited as described above, and the hinge 1 is widely applicable to a rotation part of openable and closable equipment. The hinge 1 can also be used, for example, for connecting, to a main body of office equipment, a hatch (lid) for replacing a toner cartridge in an openable and closable manner, for connecting a hood to a body of an automobile in an openable and closable manner, for connecting a toilet seat to a toilet bowl in an openable and closable manner, and the like.

As illustrated in FIG. 1, the flexible display 100 is a display device that is capable of displaying various types of information and is foldable. A part of the flexible display 100 that rotates when the flexible display 100 is folded serves as the rotation part 101. The flexible display 100 includes two rotation parts 101, but the number of rotation parts 101 is not limited to such a number, and may include one or at least three rotation parts 101.

Four hinges 1 are provided in each rotation part 101 of the flexible display 100 along the axial direction of the rotation axis 102. The number of hinges 1 provided in the rotation part 101 of the flexible display 100, however, is not limited to such a number, and may be determined as desired in accordance with the specification of the rotation part 101. The hinge 1 is set so that the angle of rotation of the rotation part 101 is 180° when the rotation part 101 is in the fully opened state and the angle of rotation of the rotation part 101 is 0° when the rotation part 101 is in the closed state.

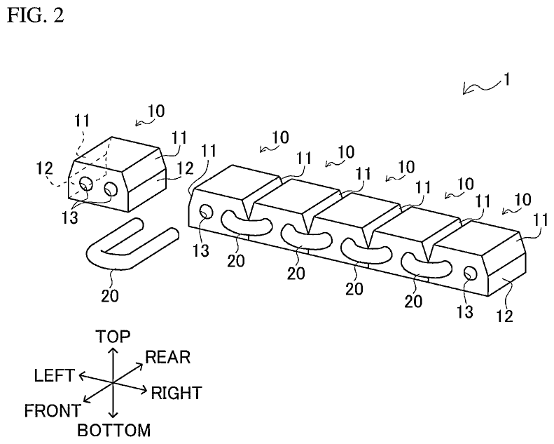

As illustrated in FIG. 2 to FIG. 5, the hinge 1 includes a plurality of (six) rotation members 10, 10, . . . and a plurality of (five for a front side and five for a rear side) connection members 20, 20, . . . .

Each rotation member 10 includes a fully open abutting part 12, a closed abutting part 11, and a pair of support holes 13, 13.

The plurality of rotation members 10 are arranged side by side in a direction orthogonal to the rotation axis 102 of the rotation part 101 (left-right direction). Adjacent rotation members 10 are in contact with each other.

Each rotation member 10 has a hexagonal cross-sectional shape when viewed along the axial direction of the rotation axis 102 of the rotation part 101 (in side view) and is bilaterally symmetrical. Adjacent surfaces (surfaces each facing an adjacent rotation member 10 when the hinge 1 is in the fully opened state) are formed in a polygonal shape. The adjacent surfaces are formed in an approximately V shape (obtuse V shape) in side view. Boundaries between inner surfaces (surfaces adjacent to the rotation axis 102) in the rotation direction of the rotation part 101 and surfaces facing each other in the fully opened state are linearly cut in side view.

A portion of the rotation member 10 that abuts the adjacent rotation member 10 in the fully opened state serves as the fully open abutting part 12. A cutaway portion of each of the adjacent surfaces serves as the closed abutting part 11 and abuts the adjacent rotation member 10 in the closed state.

The fully open abutting part 12 and the closed abutting part 11 of the rotation member 10 are contiguous with each other in the direction orthogonal to the rotation axis 102 of the rotation part 101.

Each support hole 13 of the rotation member 10 is structured to extend through surfaces of the rotation member 10 in the axial direction of the rotation axis 102 of the rotation part 101 (in the front-rear direction). The support hole 13 is opened on the surfaces (front surface and rear surface) of the rotation member 10 in the axial direction of the rotation axis 102 of the rotation part 101. The pair of support holes 13 are arranged side by side on an approximately center of the rotation member 10 in the up-down direction.

Each connection member 20 is made of an elastically deformable material such as a metal material, a rubber material, or a highly stretchable resin material such as nylon and connects the adjacent rotation members 10 with the adjacent surfaces of the adjacent rotation members 10 in contact with each other. The connection member 20 causes the surfaces of the adjacent rotation members 10 to come close to each other. The connection member 20 connects the adjacent rotation members 10 so as to cause the fully open abutting parts 12 of the adjacent rotation members 10 to abut each other in the fully opened state of the hinge 1 and cause the closed abutting parts 11 of the adjacent rotation members 10 to abut each other in the closed state of the hinge 1.

The connection member 20 is a round bar member and is formed in an approximately U shape in plan view by a pair of portions extending in the front-rear direction and a portion connecting the pair of extending portions. The connection member 20 is approximately identical in diameter to the support holes 13 of the rotation member 10.

One of the portions extending in the front-rear direction of the connection member 20 is inserted into the support hole 13 (one of the left and right support holes 13) of one of the adjacent rotation members 10, and the other of the portions extending in the front-rear direction of the connection member 20 is inserted into the support hole 13 (the other of the left and right support holes 13) of the other of the adjacent rotation members 10. The one of the extending portions and the other of the extending portions of the connection member 20 are press-fitted into the support holes 13 of the rotation members 10 in such a manner as to make the rotation members 10 rotatable relative to the connection member 20. The connection member 20 causes the surfaces of the adjacent rotation members 10 to come close to each other by the one of the extending portions and the other of the extending portions so as to maintain a state where the adjacent surfaces of the adjacent rotation members 10 abut each other. The connection member 20 maintains such a state to connect the adjacent rotation members 10.

As described above, since the rotation member 10 includes the fully open abutting part 12 and the closed abutting part 11, the fully open abutting parts 12 of the adjacent rotation members 10 abut each other in the fully opened state of the rotation part 101 to prevent the rotation part 101 in the fully opened state from further rotating, and the closed abutting parts 11 of the adjacent rotation members 10 abut each other in the closed state of the rotation part 101 to prevent the rotation part 101 in the closed state from further rotating.

Such a structure can maintain, in a simple manner, the rotation part 101 in the fully opened state or the closed state. Further, such a structure can prevent, in a simple manner, electronic elements and the like making up the flexible display 100 from being damaged when the rotation part 101 rotates further than a set range (for example, the fully opened state or the closed state).

As described above, the surface of the rotation member 10 facing the adjacent rotation member 10 is formed in a polygonal shape in which the fully open abutting part 12 and the closed abutting part 11 are contiguous when viewed along the axial direction of the rotation axis 102 of the rotation part 101.

Such a structure can maintain, in a simple manner, the rotation part 101 in the fully opened state or the closed state.

As described above, the rotation member 10 includes the support holes 13, and the connection member 20 has one of the extending portion inserted into the support hole 13 of one of the adjacent rotation members 10 and has the other of the extending portions inserted into the support hole 13 of the other of the adjacent rotation members 10 to connect the adjacent rotation members 10.

Such a structure can maintain, in a simple manner, the rotation part 101 in the fully opened state or the closed state.

As described above, the connection member 20 causes the surfaces of the adjacent rotation members 10 to come close to each other to bring the adjacent rotation members 10 into contact with each other in the fully opened state or the closed state of the rotation part 101. Further, the one of the extending portions and the other of the extending portions of the connection member 20 are press-fitted into the support holes 13 of the rotation members 10 in such a manner as to make the rotation members 10 rotatable relative to the connection member 20.

Such a structure can maintain, in a simple manner, the fully opened state (the state where the flexible display 100 is flat) or the closed state (the state where the flexible display 100 is folded) of the rotation part 101 to some extent.

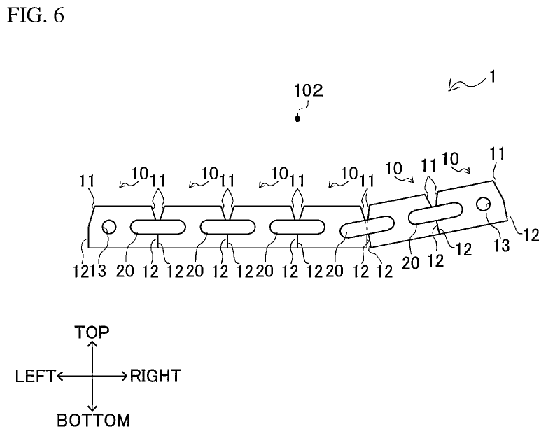

Furthermore, even when the hinge 1 is rotating in the closing direction or opening direction (a state where the hinge 1 is opening or closing), the connection member 20 causes the surfaces of the adjacent rotation members 10 to come close to each other to bring the boundaries (corner portions) between the fully open abutting parts 12 and the closed abutting parts 11 of the adjacent rotation members 10 caused to come close to each other by the connection member 20 into contact with each other (see FIG. 6).

This makes it possible to maintain, in a simple manner, an open or close angle when the rotation part 101 is opening or closing.

As described above, the hinge 1 includes six (at least three) rotation members 10, so that it is possible to cause the rotation part 101 to gently bend when the rotation part 101 is rotating (other than when the rotation members 10 are aligned in the left-right direction), at least as compared with a structure where the hinge 1 includes two rotation members 10.

Therefore, as compared with the structure where the rotation part 101 is prevented from relatively gently bending, it is possible to prevent the electronic elements and the like making up the flexible display 100 from being damaged when the rotation part 101 is rotating.

Although the hinge 1 includes the six rotation members 10, the number of the rotation members 10 is not limited to such a number, and the number may be determined as desired in accordance with the specification of the hinge 1. Needless to say, it is preferable that, in order to cause the rotation part 101 to gently bend, the number of the rotation members 10 be relatively large.

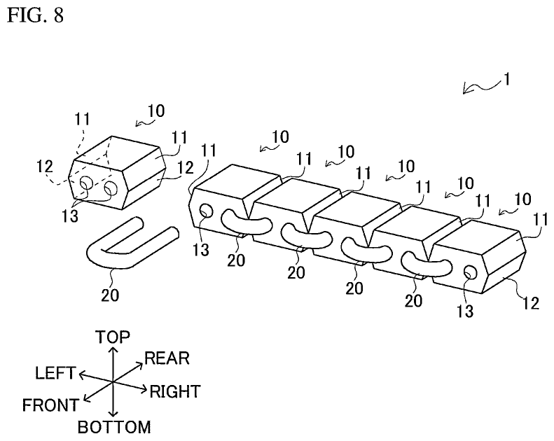

As illustrated in FIG. 8, another structure may be employed where the support holes 13 of the rotation member 10 are opened only one of the front and rear surfaces of the rotation member 10, and the connection member 20 is provided only in one of the front and rear surfaces.

Such a structure can reduce the number of components making up the hinge and thus make the hinge 1 more compact.

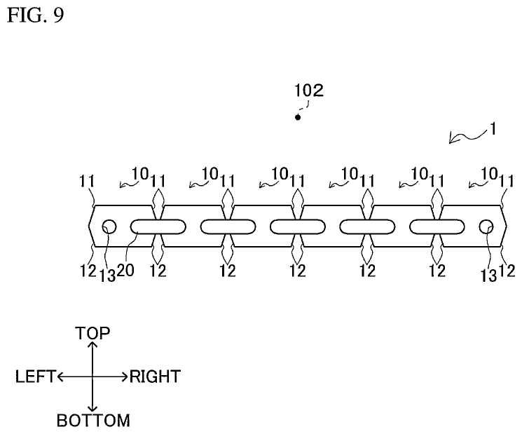

A change in specification of adjacent sides of the rotation members 10 allows the rotation angle in the fully opened state or the rotation angle in the closed state of the hinge 1 to be set to a suitable angle in accordance with the specification of the equipment in which the hinge 1 is provided. As illustrated in FIG. 9 to FIG. 11, for example, the hinge 1 may be set so that the angle of rotation of the rotation part 101 is 0° when the rotation part 101 is in the fully opened state and the angle of rotation of the rotation part 101 is 360° when the rotation part 101 is in the closed state.

At this time, the adjacent surfaces of the rotation members 10 are formed in an approximately V shape (a relatively acute V shape) in side view. In addition to a structure where the closed abutting part 11 is cut away, boundaries between outer surfaces (surfaces remote from the rotation axis 102) of the rotation members 10 in the rotation direction the rotation part 101 and surfaces facing each other in the fully opened state are linearly cut in side view. A cutaway part of each of the adjacent surfaces serves as the fully open abutting part 12 and abuts the adjacent rotation member 10 in the fully opened state.

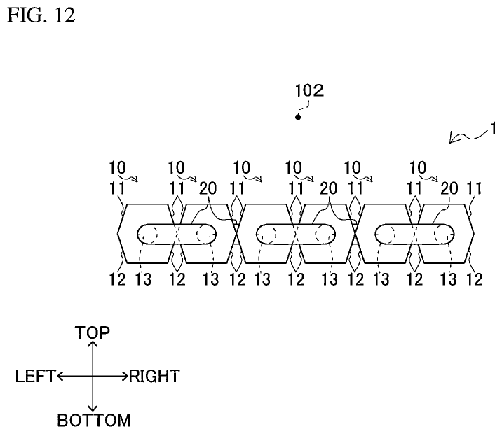

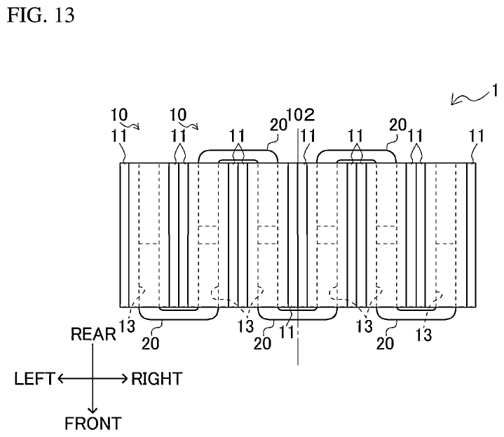

As illustrated in FIG. 12 to FIG. 13, the rotation member 10 may include a single support hole 13.

The support hole 13 is disposed at an approximately center of the rotation member 10 in both the up-down and front-rear directions.

Further, one of the portion extending in the front-rear direction of the connection member 20 is inserted into the support hole 13 of one of the adjacent rotation members 10, and the other of the portions extending in the front-rear direction of the connection member 20 is inserted into the support hole 13 of the other of the adjacent rotation members 10.

Such a structure can reduce the number of components making up the hinge 1 and thus make the hinge 1 more compact.

Another structure may be employed where the rotation member 10 includes a predetermined protrusion, the connection member 20 includes a predetermined hole, and the protrusion of the rotation member 10 is inserted into the hole of the connection member 20 to cause the connection member 20 to connect the adjacent rotation members 10. An embodiment of such a hinge 1 will be described below, but no description will be given as needed of the same configuration as the hinge 1 illustrated in FIG. 1 to FIG. 13.

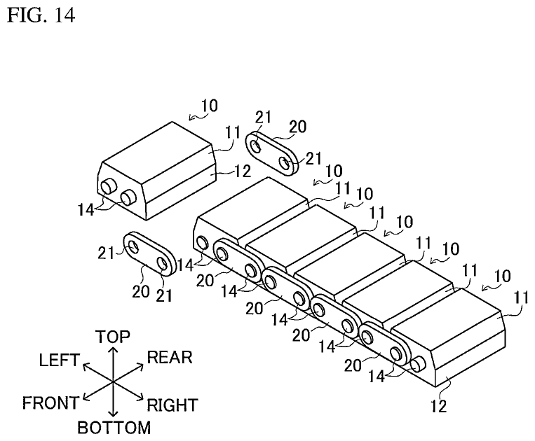

As illustrated in FIG. 14, the rotation member 10 includes the fully open abutting part 12, the closed abutting part 11, and a pair of protrusions 14.

The pair of protrusions 14, 14 protrude forward or rearward from a surface (front or rear surface) of rotation member 10 in the axial direction of rotation axis 102 of rotation part 101. Each protrusion 14 is formed in a cylindrical shape. The protrusion 14 is disposed at an approximately center of the rotation member 10 in both the up-down and front-rear directions.

The connection member 20 is a flat member having an approximately elliptical shape in side view with the left-right direction as a longitudinal direction.

The connection member 20 includes a pair of insertion holes 21, 21. Each insertion hole 21 of the connection member 20 is structured to extend through the connection member 20 in the front-rear direction. The pair of insertion holes 21 are arranged side by side in the left-right direction on an approximately center of the connection member 20 in the up-down direction. The insertion hole 21 of the connection member 20 is approximately identical in diameter to the protrusion 14 of the rotation member 10.

Then, one of the protrusions 14 of one of the adjacent rotation members 10 is inserted into one of the pair of insertion holes 21 of the connection members 20, and one of the protrusions 14 of the other of the adjacent rotation members 10 is inserted into the other of the pair of insertion holes 21 of the connection member 20. The connection member 20 maintains such a state to connect the adjacent rotation members 10.

Such a structure can maintain, in a simple manner, the rotation part 101 in the fully opened state or the closed state. Further, such a structure can prevent, in a simple manner, electronic elements and the like making up the flexible display 100 from being damaged when the rotation part 101 rotates further than a set range (for example, the fully opened state or the closed state).

Note that although the hinge 1 is provided in the rotation part in the flexible display 100, another structure may be employed where some of the plurality of rotation members 10 are secured to a part of the equipment. Specifically, a structure may be employed where the rotation members 10 located at both ends are secured to one connection target and the other connection target, respectively, and the one connection target rotates relative to the other connection target.

Further, the length of the rotation member 10 along the rotation axis 102 of the rotation part 101 may be set to a suitable length in accordance with the specification.

### REFERENCE SIGNS LIST

1 hinge
10 rotation member
11 closed abutting part
12 fully open abutting part
13 support hole
14 protrusion
20 connection member
21 insertion hole
100 flexible display
101 rotation part
102 rotation axis

1. A hinge provided in a rotation part of openable and closable equipment, the hinge comprising:
a plurality of rotation members arranged side by side in a direction orthogonal to a rotation axis of the rotation part; and
a connection member that connects the rotation members adjacent to each other while maintaining a state where adjacent surfaces of the rotation members adjacent to each other abut each other, wherein
a surface of each of the rotation members facing an adjacent rotation member includes a fully open abutting part that abuts the adjacent rotation member in a fully opened state of the rotation part and a closed abutting part that abuts the adjacent rotation member in a closed state of the rotation part,
each of the rotation members includes a support hole opened on a surface of the rotation member in an axial direction of the rotation axis of the rotation part,
the connection member is a rod member and includes a pair of extending portions and a portion connecting the pair of extending portions, and
the connection member has one of the extending portions inserted into the support hole of one of the rotation members adjacent to each other and has an other of the extending portions inserted into the support hole of the other of the rotation members adjacent to each other to connect the rotation members adjacent to each other.

2. The hinge according to claim 1, wherein
the surface of each of the rotation members facing the adjacent rotation member is formed in a polygonal shape in which the fully open abutting part and the closed abutting part are contiguous when viewed along the rotation axis of the rotation part.

3. The hinge according to claim 1, wherein
the number of the rotation members is at least three.

4. The hinge according to claim 2, wherein
the number of the rotation members is at least three.

5. Foldable equipment comprising a hinge according to claim 1.

6. Foldable equipment comprising a hinge according to claim 2.

7. Foldable equipment comprising a hinge according to claim 3.

8. Foldable equipment comprising a hinge according to claim 4.
